(19) United States
(12) Patent Application Publication
(10) Pub. No.: US 2008/0320374 A1
(43) Pub. Date: Dec. 25, 2008

(54) METHOD AND APPARATUS FOR DECODING A LDPC CODE

(75) Inventors: Abhiram PRABHAKAR, Fremont, CA (US); Zhong Yan, San Jose, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 11/767,466

(22) Filed: Jun. 22, 2007

(51) Int. Cl. G06F 11/00

(52) U.S. Cl. 714/801; 714/E11.001

(57) ABSTRACT

In a decoder having a predetermined decoder structure for decoding a low density parity check (LDPC) code suitable for decoding multi-rated LDPC codes is provided. An associated method is provided. The method comprises the steps of: providing a memory for the decoding with the memory size proportional to the number of circularly shifted-identity matrices I (t); and providing a number M for both row update unit numbers and column-update unit numbers. Whereby an improved architecture having an improved logic and the memory is provided such that an improved throughput, power consumption, and memory area are achieved.

### FIELD OF THE INVENTION

The present invention relates generally to LDPC decoders, more specifically the present invention relates to a LDPC ASIC decoder having improved architecture for throughput, power, memory, and chip area.

### BACKGROUND

Data communication systems have been under continual development for many years. Typically, two types of communication systems exist. They are a communication system that employs turbo codes and a communication system that employs LDPC (Low Density Parity Check) codes. Each of these different types of communication systems is able to achieve reliable communication with very low BERs (Bit Error Rates). Lowering the required signal to noise ratio (SNR) for reliable error free communication is of great significance in communication systems. Ideally, the goal is to try to reach Shannon's limit in a communication channel. Shannon's limit can be viewed as the data rate used in a communication channel with a particular SNR that achieves error free transmission through the communication channel. In other words, the Shannon limit is the theoretical bound for channel capacity for a given modulation and channel. LDPC codes have been shown to provide an excellent decoding performance that can approach the Shannon limit in some cases. For example, some LDPC codes have been shown to come within 0.0045 dB (decibels) of Shannon limit for an AWGN (Additive white Gaussian noise) channel.

LDPC decoders have traditionally been designed for a specific parity check matrix, H. Thus, the block length that the decoder processes and the rate of the code are fixed for a particular architecture. A need therefore exists for improved LDPC decoders that can support a plurality of code block lengths and code rates. A further need exists for a LDPC decoder that has improved architecture for hardware implementation to achieve higher throughput, lower power consumption and decrease chip area.

### SUMMARY OF THE INVENTION

The present invention provides an improved architecture in the logic and the memory such that an improved throughput, power consumption and memory area is achieved.

In a decoder having a predetermined decoder structure for decoding a low density parity check (LDPC) code suitable for decoding multi-rated LDPC codes is provided. An associated method is provided. The method comprises the steps of:

providing a memory for the decoding with the memory size proportional to the number of circularly shifted-identity matrices I (t); and providing a number M for both row update unit numbers and column-update unit numbers. Whereby an improved architecture having an improved logic and the memory is provided such that an improved throughput, power consumption, and memory area are achieved.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a Tanner graph associated with a LDPC decoder with some embodiments of the invention.

FIGS. 2A-2B is an example of a parity check matrix of the present invention.

FIG. 3 is an example of a block diagram in accordance with some embodiments of the invention.

FIGS. 4A-4C are examples of a set of practical parity check matrices of the present invention.

FIGS. 5A-5C depict an exaplified flowchart in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a LDPC decoder having improved logic architecture. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

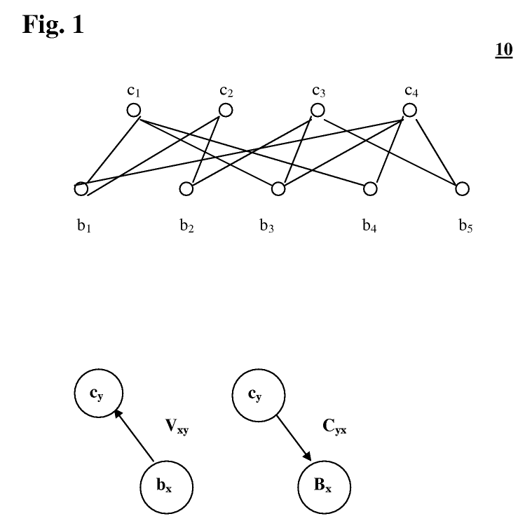

Referring to FIG. 1, a bipartite or tanner graph is shown. The parity check matrix of an LDPC code is well represented by a bipartite or tanner graph as shown. Such a graph has two types of nodes namely the variable nodes and check nodes. Each column in the parity check matrix is represented by a variable node and each row in the parity check matrix is represented by a check node. A node is identified by a variable pair (i,j) representing the location of the row/column in the block matrix and its sub-location within the block after expansion. Each “1” in the parity check matrix is represented by a connection between a variable node and a check node corresponding to a column and a row position associated with the “1”.

A regular LDPC code is one where all the bit and check nodes have the same degree (i.e. each row or column of a parity check matrix has the same number of “I”s). An irregular LDPC code has bit nodes/check nodes with different degrees. In other words, rows/columns have different numbers of “I”s. An LDPC code is defined by its bit node degree profile and check node degree profile. The degree profile defines how many nodes of a particular degree are there. Given a degree profile, the LDPC code is constructed by randomly connecting the bit nodes with check nodes. Such a random construction is not suitable for a hardware LDPC decoder due to addressing and routing complexities. Recently LDPC parity check matrices that are constructed from sub-blocks of circularly shifted identity matrices and zero matrices have been proposed. An example of such a proposal can be found in a TDS-OFDM system.

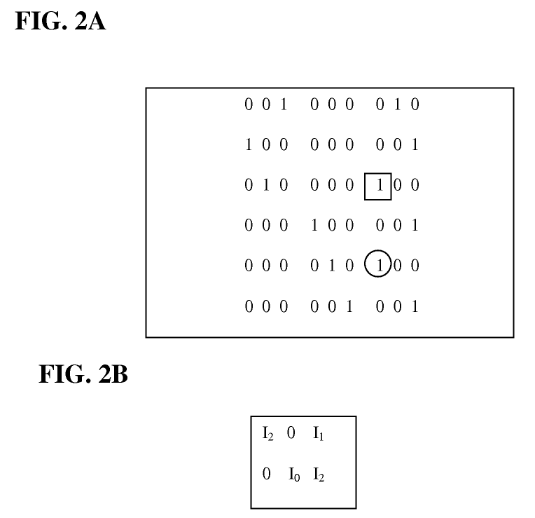

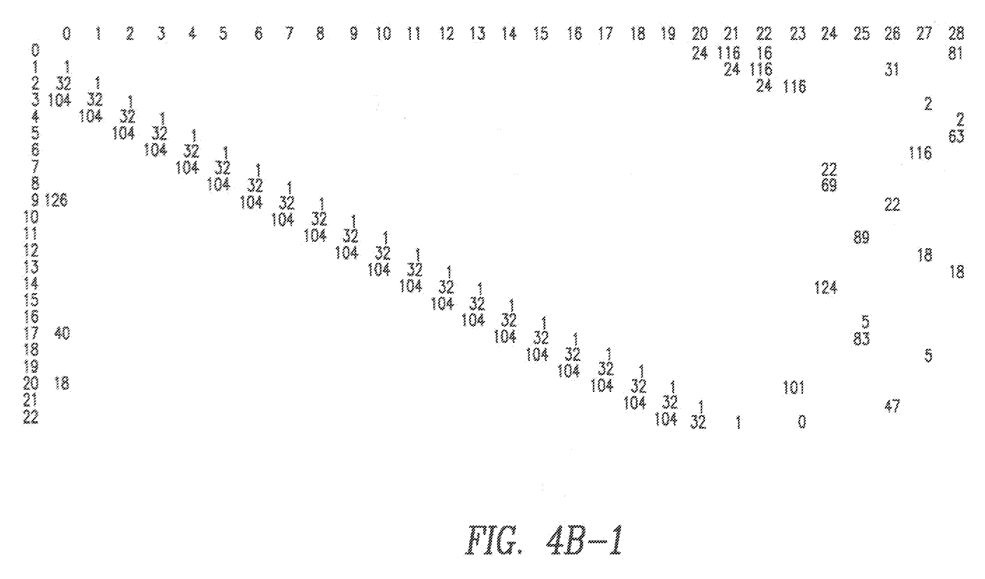

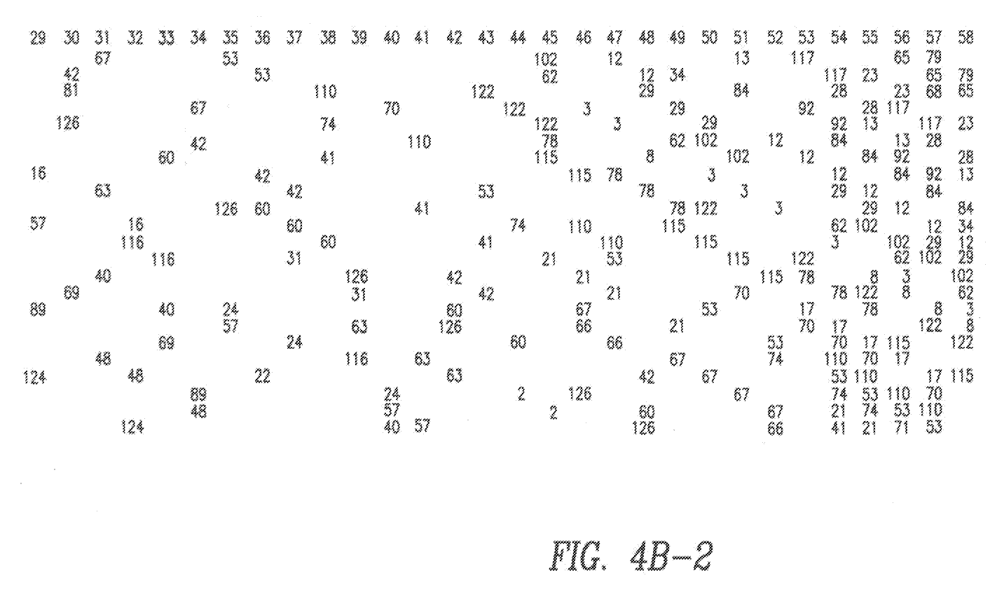

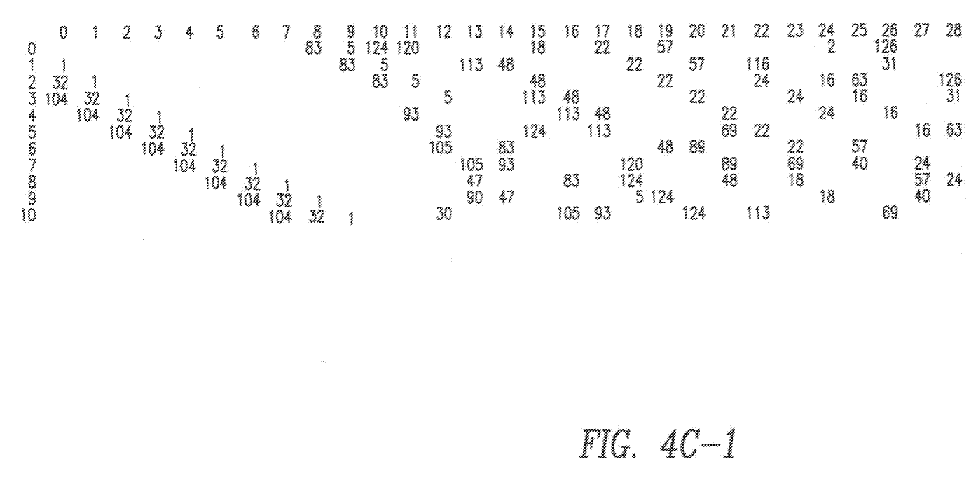

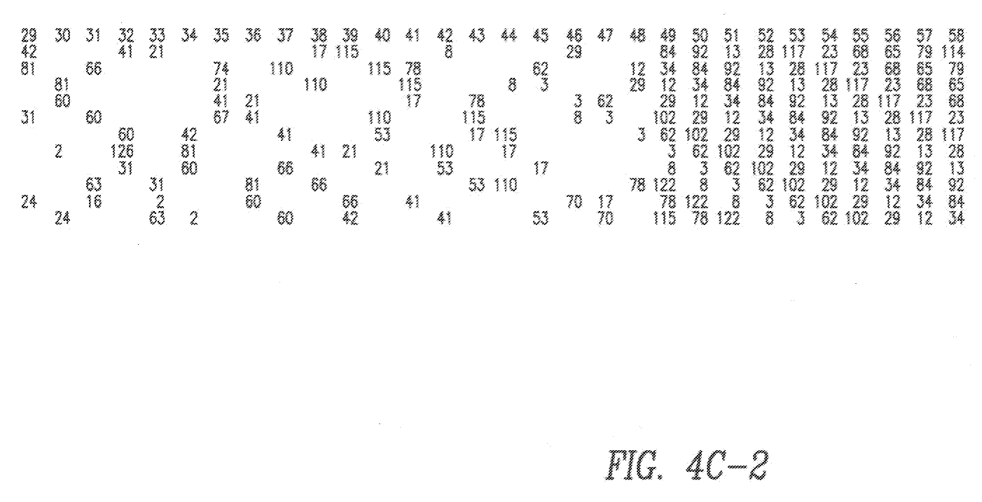

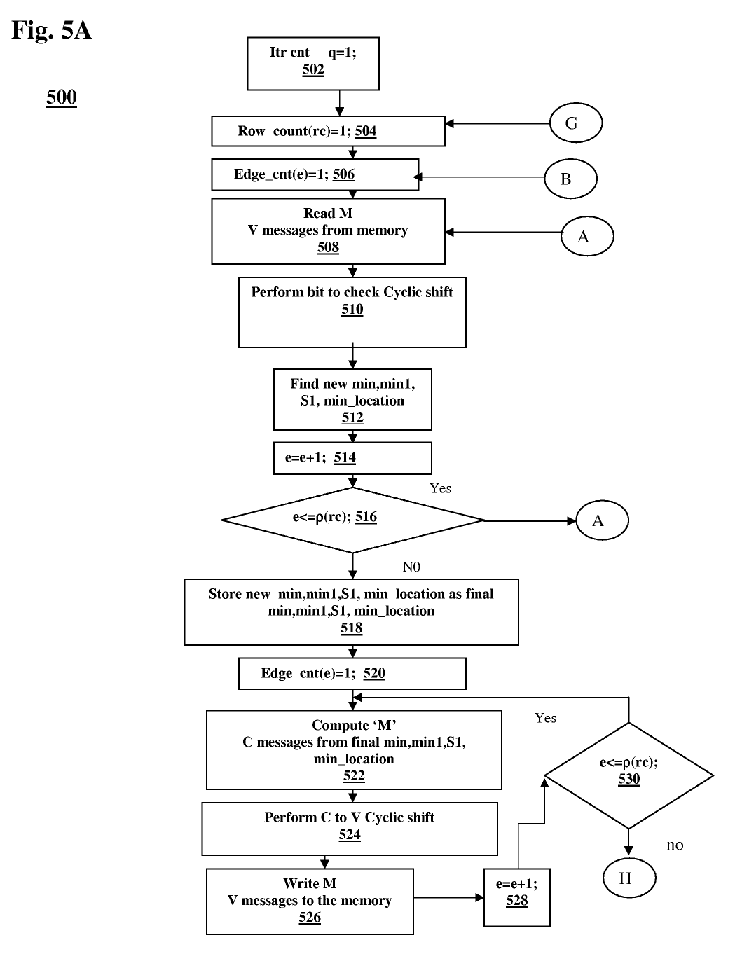

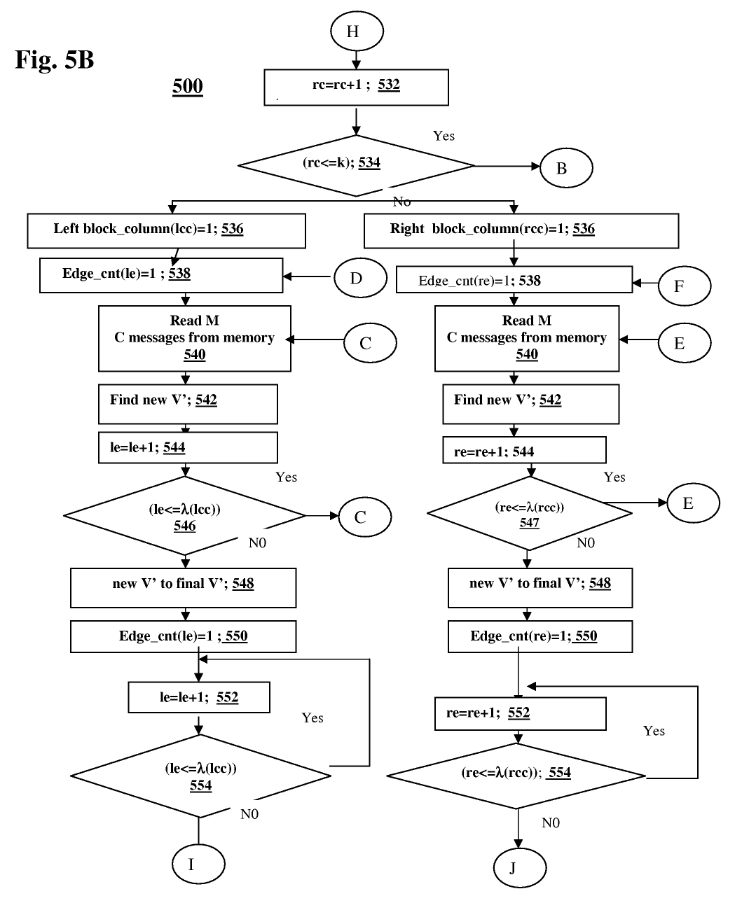

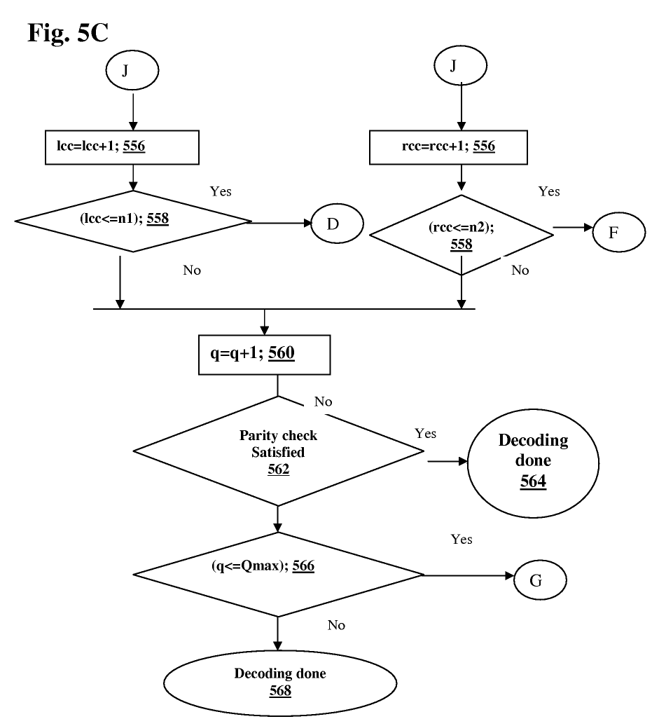

For the convenience of notation and explanation, the structure of the parity check matrix is given in FIG. 2A. This matrix of “1”s and “0”s can be conveniently represented by as block matrix. The rows of this block matrix are called block rows, and columns of this matrix are called block columns. Referring to FIG. 2B, each cyclic shifted matrix in FIG. 2A is represented by a I with the shift as subscript. In this example, the dimensions of the code are kept small for illustration purposes only therefore does not represent an actual LDPC code. FIG. 4A shows an actual representation of a LDPC parity check matrix where the notation ‘I’ is dropped out and only the number of shifts is shown. In communication systems, the LDPC code operates at various code rates, depending on the state of the channel. Therefore, a LDPC decoder architecture preferably should support multi-rated LDPC decoding and not merely a single LDPC code.

In an exemplified TDS-OFDM system, the parity check matrix of the LDPC codes can be represented by a block matrix of “1”s and “0”s. Three different parity check matrices are used in the example. That is to say, one matrix for each rate of communication (i.e. rates: 0.4, 0.6, and 0.8). The parity check matrix can be represented in short by a block matrix. In our example, the number of block columns for each of the parity check matrix is 59. The number of block rows for each parity check matrix defers with the rate of the code. For the rate 0.4 code the number of block rows is 35, for the rate 0.6 code the number of block rows is 23, and for the rate 0.8 code the number of block rows is 11. The position of “1”s and 0's differs for each block matrix and is as defined by the example. The actual parity check matrix used in the system can be obtained by replacing each one in the block matrix with a circularly shifted identity matrix I and each zero in the block matrix with a square matrix of all zeros's. The size of this square matrix is 127(M). The structures of these 3 codes are given in FIGS. 4A-4C.

Decoding of LDPC codes typically involves an iterative algorithm based on the belief propagration model. The decoding algorithm for LDPC codes is based on passing messages between variable nodes and check nodes along the edges of the graph in an iterative manner. The messages represent estimates of the coded bits (LLR) based on the received signal from the channel and parity check constraints. Two different updates are to be performed during each iteration, namely column-update (variable node update) and row update (check node update).

A model is constructed such that L_{ch} represent the LLR value received from the channel; V (i,j,k) represent the LLR message along the k^{th} edge of the j^{th} variable node in i^{th} block column after a variable node update, for example, as shown in FIG. 2A, the squared unit has index given by i=3, j=1, and k=1, and the circled unit has index given by i=3, j=2, and k=2. C (i,j,k) represent the LLR message along the k^{th} edge of the j^{th} check node in i^{th} block row after a check node update. The number of “I”s in a block column is represented by λ(i) and the number of “I”s in a block row is represented by ρ(i). The λ's, and ρ's for various parity check matrix are as defined in the example. Transformation x defines a block row number of the check node connected to an edge from the variable node. Transformation y defines a sub-position of the check node inside the block row. Transformation z defines the actual edge of the check node to which it is connected. Similarly, transformation X defines the block column number of the variable node to which an edge from the check node is connected. Transformation Y defines a sub-position of the variable node inside a block column. Transformation Z defines the actual edge of the bit node to which it is connected. For example, in FIG. 2A

x (3, 1, 1) 1,

y (3, 1, 1) 3,

z (3, 1, 1) 2. With the inverse as follows:

X (1, 3, 2) 3,

Y (1, 3, 2) 1

Z (1, 3, 2) 1

There are various LDPC decoding methods that can be used for decoding LDPC codes. SPA (Sum Product Algorithm) and Min-sum algorithm are the commonly used methods. While the variable node update remains the same for all LDPC decoding methods, the check node update varies. The present invention uses min-sum method. Using SPA instead, would change the apparatus for check node update and all the other blocks would remain the same. The variable node/column update is given by:

$$V ( i , j , k ) = Lch ( i , j ) + {\sum }_{l = 1 / k}^{λ ( i )} C ( x ( l , i , j ) , y ( l , i , j ) , z ( l , i , j ) ) \qquad ( eq . 1 )$$

where “/k” means that the value along the k^{th} edge is excluded.
The check node/row update is given by,

$${C}^{′} ( i , j , k ) ) = min ( magnitude ( V ( X ( l , i , j ) , Y ( l , i , j ) , Z ( l , i , j ) ) ) l = 0 to ρ ( i ) / k \\ magnitude ( C ( i , j , k ) ) = corrected ( {C}^{′} ( i , j , k ) ) \\ sign ( C ( i , j , k ) ) = {\prod }_{l = 1}^{l = ρ ( i ) / k} V ( X ( l , i , j ) , Y ( l , i , j ) , Z ( l , i , j ) ) \qquad ( eq . 2 )$$

The decoding algorithm can be summarized by the following pseudo-code:

```
For q= 0 to maximum number of iterations for the design (Qmax)
  (Bit-node update)
  For i= 1 to number of block columns (n)
    For j=1 to M (size of each block column)
      For k=1 to λ(i)
```

$V ( i , j , k , q ) = Lch ( i , j ) + {\sum }_{l = 1 / k}^{λ ( i )} C ( x ( l , i , j ) , y ( l , i , j ) , z ( l , i , j ) , q - 1 )$

```
(Check-node update)
  For i=1 to number of block rows (k)
    For j=1 to M (size of each block row)
      For k= 1 to ρ(i)
C′(i, j, k) = min(magnitude(V(X(l, i, j), Y(l, i, j), Z(l, i, j)))l = 0to ρ(i) l k
magnitude(C(i, j, k)) = corrected(C′(i, j, k))
$sign ( C ( i , j , k ) ) = {\prod }_{l = 0}^{l = ρ ( i ) / k} V ( X ( l , i , j ) , Y ( l , i , j ) , Z ( l , i , j ) )$
The soft decision on each bit is given by,
```

$V ( i , j , q ) = Lch ( i , j ) + {\sum }_{l = 1}^{λ ( i )} C ( x ( l , i , j ) , y ( l , i , j ) , z ( l , i , j ) , q - 1 )$

The hard decision is given by,
H(i, j, q) =0 if V(i, j, q) >=0 else H(i, j, q)=1.

Once the hard decisions are made for each bit, one checks if all the parity check constraints are satisfied. If the result is true then no more iterations are needed, otherwise one proceeds for the next iteration and continue the iteration process until the predetermined maximum number of iterations allowed for the decoder are reached.

In hardware implementation, the logic and memory for executing the above pseudo-code is provided. The architecture of the logic and memory used determines the area, power consumption, and throughput for the decoder. The present invention provides an improved architecture in the logic and the memory such that an improved throughput, power consumption and memory area is achieved. The present invention further provides for multi-rated decoding. The values of various parameters are used as a trade off in order to obtain a hardware implementation that suits the requirements of the system.

The requirements of various components are limited by the maximum of the requirements for each code decoded in the communication system. As can be seen, in the example the same decoder has to handle any one of the three different codes and the requirements of the memory are limited by the maximum requirement among all three different codes as the number of non-zero entries or “1”s is different for each parity check matrix. Hence the memory requirement for the decoder is dependent on the parity check matrix with maximum number of “1”s. The following are the specifics of the hardware implementation. The hardware implementation may be used in similar implantations in any LDPC code other than the examples listed herein that has a parity check matrix structure similar to the one used in this example.

In the exemplified architecture, M (127) row update/check-node update units are used i.e. we use a row update unit for each row in the square-sub block I. Further, each row update unit is a serial type unit. It can take one V message as input for the present row and produces one C message as output from the previous row at any time. Two sets of M (127) column update/bit-node update units are used. One set of M column-update units (left column-update unit) is used for block columns of smaller X and the other set will be used for block columns of larger λ(right column-update unit). Each column-update unit is a serial type unit. It takes one C message as input for the present column and produces one V messages as output from the previous column any time. The C/V message memory is partitioned to two blocks each with M values width to read/write to and from the two column-update units.

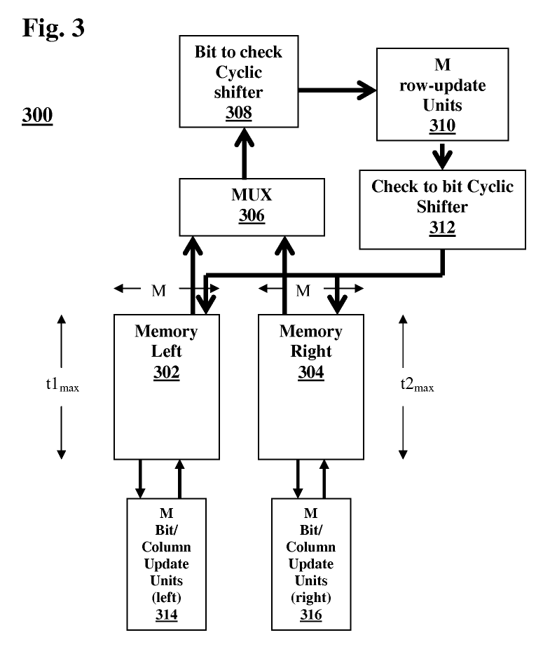

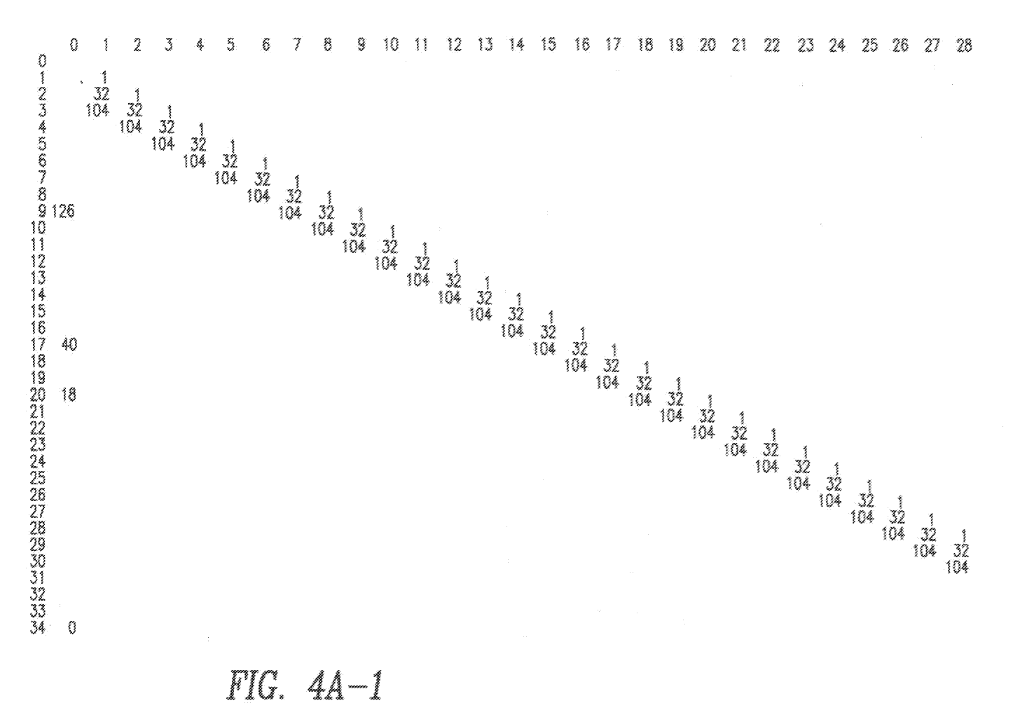

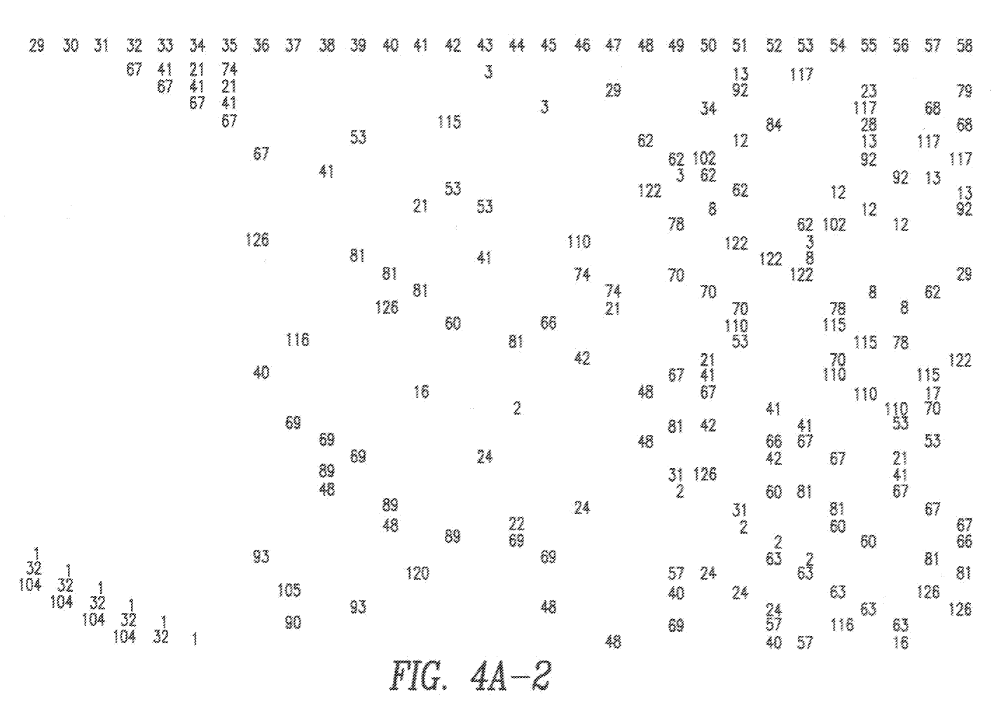

Referring to FIG. 3, a block diagram 300 is shown. A set of memory blocks including left memory 302 and right memory 304 is shown. These blocks store the V or C messages in a time multiplexed manner. A row multiplex 306 is coupled to memory blocks 302,304 retrieving data for row updates 1-M. The Row multiplex 306 is coupled to a cyclic shifter 308 referred to here as a bit to check cyclic shifter. The cyclic shifter routes the data retrieved from the memory to the appropriate row update units. The M row-update units 310, perform operations corresponding to equations (3) and (4). The cyclic shifter 312 referred to here as check to bit cyclic shifter routes the output of the M row-update units to the appropriate memory locations. Column-update units 312 and 314 coupled to memories 308 and 310 respectively perform operations corresponding to equation (5).

Row-update units: The row update unit implements eq. (2). For efficient hardware implementation, eq. (2) can be rewritten as the following:

$${C}^{′} ( i , j , k ) = min ( magnitude ( V ( X ( l , i , j ) , Y ( l , i , j ) , Z ( l , i , j ) ) ) l = 0 to ρ ( i ) / k = min ( magnitude ( V ( l , i , j ) , Y ( l , i , j ) , Z ( l , i , j ) ) ) l = 0 to ρ ( i ) i f k \neq min edge \\ else \\ = min 1 ( magnitude ( V ( X ( l , i , j ) , Y ( l , i , j ) , Z ( l , i , j ) ) ) l = 0 to ρ ( i ) i f k = min edge \qquad ( eq . 3 )$$

Since the minimum among ρ(i) inputs excluding itself can either be the minimum among the ρ(i) inputs or it can be the next minimum if the excluded edge is the minimum edge among the ρ(i) inputs, hardware logic for all ρ(i) edges in the row-update units is not needed. One can find min and min₁ and can use one of these as output for the magnitude of ρ(i) edges. Similarly, logic to find the sign of each edge separately is not needed. One can find the product of all the signs for the node and exclude the edge k by multiplying the total product with the sign of the k^{th} edge.

$$sign ( C ( i , j , k ) ) = {\sum }_{l = 1}^{l = ρ ( i ) / k} V ( X ( l , i , j ) , Y ( l , i , j ) , Z ( l , i , j ) ) \\ canbewrittenas \\ S 1 = {\prod }_{l = 1}^{l = ρ ( i )} V ( X ( l , i , j ) , Y ( l , i , j ) , Z ( l , i , j ) ) \\ sign ( C ( i , j , k ) ) = S 1 * sign ( V ( X ( k , i , j ) , Y ( k , i , j ) , Z ( k , i , j ) ) \qquad ( eq . 4 )$$

Also each C′(i,j,k) undergoes correction as mentioned in U.S. patent application Ser. No. 11/550,394 to Haiyun Yang which is hereby incorporated herein by reference.

Each row update unit is of serial-type. Number ‘M’ such units are provided to compute ‘M’ row updates of a block row in parallel. Each unit can take one V message as input for the present block row and produces one C message as output from the previous block row at any time. A serial-type unit computes eq 3 in ρ(i) steps i.e. the same unit is time shared for each edge of a check-node/row update. While (V(X(l,i,j),Y(l,i,j),Z(l,i,j)) is the input for the present row and min, min1 for the present block row is updated the output of the unit is C(I-1,j,l) of the previous block row, which is based on the final min/min1 of the previous block row. Hence we have a pipelined architecture between two block rows. The same set of M row update units are also time-shared for all the block rows. Hence the row update units are time shared between the ‘I’s of a single row and between rows of each block row. Since the row update units are of serial-type and time-shared between the edges of a check-update they are independent of ρ(i). In other words the same unit can be used irrespective of the number of I's in a block row (number of edges of a check node).

Column-update units: The column-update unit takes the λ(i) inputs for the block column and the Lch input from the channel and computes V(i,j,k) according to eq(1). eq(1) is split into 2 parts in order to minimize the logic needed to find the sum for each of the λ(i) edges. In other words, the sum for each edge is not computed separately. Thus, the split are as follows:

$${V}^{′} = L c h ( i , j ) + {\sum }_{l = 1 / k}^{λ ( i )} C ( x ( l , i , j ) , y ( l , i , j ) , z ( l , i , j ) ) \\ V ( i , j , k ) = {V}^{′} - C ( x ( k , i , j ) , y ( k , i , j ) , z ( k , i , j ) ) \qquad eq ( 5 )$$

For serial-type column-update units, ‘M’ such units are provided to compute ‘M’ column-updates of a block column in parallel. It can take one C message as input for the present column and produces one V message as output from the previous column at any time. A serial-type unit computes eq 4 in λ(i) steps i.e. the same unit is time shared for each edge of a bit-node/column update. While (C(x(l,i,j), y(l,i,j), z(l,i,j)) is the input for the present block column and V′ is updated the output of the unit is V (I-1,j,l) of the previous block column which is based on the final V′ of the previous block column. Hence a pipelined architecture is achieved between two block columns. The same set of M row update units are also time-shared for all the block rows. Hence the row update units are time shared between the ‘I’s of a single column and between columns of each block column as well. Since the column-update units are of serial-type and time-shared between the edges of a bit-update they are independent of λ(i). In other words the same unit can be used irrespective of the number of I's in a block column (number of edges of a bit node).

The λ(i)'s vary quite a lot between various block columns. For a rate 0.8 code λ(1)=3 and λ(59)=11. To increase the throughput of the decoder two sets of ‘M’ column-update units referred to as ‘left column-update units’ and ‘right column-update units’ that operate in parallel are used. The left column-update units operate on block columns n1=1 to 44 the right column-update units operate on block columns n2=45 to 59. The memory is partitioned into two blocks to facilitate parallel operation of left and right column-update units as explained in the next section.

2's complement circuits are also needed to convert the C messages, which are in sign-magnitude form to 2's complement form. Also the output V messages with are in 2's complement form have to be converted to sign-magnitude form for the row-update unit.

Memory: The C and V messages are time shared and stored in the memory. In other words, each memory unit either stores a C type message or a V type message depending on the time considered. The total memory requirement is given by the total number of “1”s in the parity check matrix which is the total number of “I”s in the block matrix T=t*M (127). Since we have more than one parity check matrix the total requirement is maximum of ‘T’ among the different codes (Tₘₐₓ). Since we have ‘M’ row update units working in parallel we need to write/read ‘M’ messages to/from the memory simultaneously. Hence the width of the memory blocks should be ‘M’ messages. Also, we have two sets of ‘M’ column-update units. Hence we need two blocks of memory each ‘M’ messages wide. The quantity ‘t’ can further be subdivided into ‘t1’ corresponding to the number of ‘I’s in block columns ‘n1’ (1 to 44) and ‘t2’ corresponding to the number of ‘I’s in block columns ‘n2’ (45 to 59). Let ‘t1ₘₐₓ’ represent the maximum of ‘t1’ among the various code-rates and ‘t2ₘₐₓ’ represent the maximum of ‘t2’. The number of words/memory depth of left memory is ‘t1ₘₐₓ’ and the number of words/memory depth of right memory is ‘t2ₘₐₓ’. The left and write memory blocks are implemented as dual-port memory blocks to facilitate simultaneous write and read from two different memory locations. This memory arrangement is shown in FIG. 3.

The V values read from the memory are routed to the correct row/check update units using a bit to check cyclic shifter. Similarly the output of row update units (C messages) are shifted using a check to bit cyclic shifter and written into the memory. The bit to check and check to bit cyclic shifters can produce a shift between 1 to M and shift the message order in opposite directions.

The following flow chart/block diagram summarizes the whole architecture.

Start iteration by setting q=1 (Step 502). Start row count by setting rc=1 (Step 504). Start edge count by setting e=1 (Step 506). Read ‘M’ different V messages simultaneously from the memory (Step 508). Perform bit to check cyclic shift on the ‘M’ messages to route them to the appropriate row update units (Step 510). The ‘M’ row update units, update the ‘min, min1, S1, min_location’ values depending on the present input (Step 512). Here, min and min1 are as defined in eq 3, S1 as defined in eq 4 and min_location is the edge count at which min occurs. Increment the edge count by setting e=e+1 (Step 514); and check if all the edges of the check (row update) have been read (Step 516). If the resultant edge count is still less or equal to ρ(rc), revert to Step 508, otherwise transfer the updated ‘min, min1, S1, min_location’ as final ‘min, min1, S1, min_location’ values (Step 518). Start, in turn, edge count by setting e=1 (Step 520), compute ‘M’ C messages using the final ‘min, min1, S1, min_location’ values (Step 522). Perform check to bit cyclic shift on the ‘M’ messages (Step 524) and store them back in the memory (Step 526). Increment the edge count by setting e=e+1 (Step 528) and check if ‘C’ messages for all the edges of the check have been computed (Step 530). If still less than ρ(rc), revert to step 522, otherwise increment the row count rc by setting rc=rc+1 (Step 532). Check if the row count is less than ‘k’ (Step 534). If the row count is still less than ‘k’, revert to step 506, otherwise initialize the left column count and right column count to 1 (Step 536).

Since we have two sets of ‘M’ column-update units that perform identical operations the flow chart splits into left and right branches. The following steps happen in parallel for both the left and right branches. Set the edge count ‘e’ to 1 (Step 538). Read ‘M’ C messages from the memory (Step 540). Compute V′(Step 542) and increment the right and left column counters. Increment the edge count (Step 544). For left branch check if le<=λ(lcc) (Step 546) and for right branch check if re<=λ(rcc) (Step 547). If satisfied revert to step 540 else mark the contents of V′ as final V′ (Step 548). Set the edge count ‘e’ to 1 (Step 550). Compute ‘M’ V messages from V′ and write them back to the memory (Step 551). Increment the edge count (Step 552). If V message has not been computed for all the edges of a bit-node (column) revert back to step 552 else, increment the column counter lcc/rcc (Step 556). Check if column-update has been completed for all block columns lcc<n1 & rcc<n2 (Step 558). If all column updates are over, increment the iteration count q (Step 560). Otherwise, revert back to step 538. Compute the parity checks and check to see if they are satisfied (Step 562). If satisfied, the present decoding is complete and the output of the decoder is a valid codeword (Step 564), else check if the maximum number of iterations Qₘₐₓ is reached (Step 566). If Qₘₐₓ is not reached, revert back to Step 504. Otherwise, the decoding process is over without correcting all the errors and the resulting output is not a codeword (Step 568).

As can be seen, the present invention provides a scheme wherein the number of row update units is M, with M being the size of square sub-block. Similarly, the number of column-update units is also M (the size of square sub-block). Memory size used is proportional to the number of circularly shifted identity matrices I (t). Further, the decoder structure is independent of the number of 1's in each row (check-node degree) or the number of 1's in each column (bi-node degree). Also the decoder structure is independent of the number of block columns or block rows in the parity check matrix. The decoding time is proportional to the number of I's within the parity check matrix (t). Further, the decoding time is independent of the size of the square sub-block matrix M. The same decoder is used for decoding multi-rate codes. Still further, a pipelined architecture is provided for bit and check update units, thereby increasing efficiency in processing. (By piplined architecture for check update, it is meant that when min and min1 are computed for the present row, C (i, j, k) is computed for the previous row. Similarly for bit update units when V′ is computed for the present column V (i, j, k) is computed for previous column).

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “example,” and terms of similar meaning should not be construed as limiting the item described to a given time period or to an item available as of a given time, but instead should be read to encompass conventional, traditional, normal, or example technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. In a decoder having a predetermined decoder structure for decoding a low density parity check (LDPC) code suitable for decoding multi-rated LDPC codes, a method comprising the steps of:
providing a memory for the decoding with the memory size proportional to the number of circularly shifted-identity matrices I (t); and
providing a number M for both row update unit numbers and column-update unit numbers;
whereby an improved architecture in a logic and the memory is provided such that an improved throughput, power consumption, and memory area are achieved.

2. The method of claim 1, wherein the decoder structure is independent of the number of 1's in each row (check-node degree) or the number of 1's in each column (bi-node degree).

3. The method of claim 1, wherein the decoder structure is independent of the number of block columns or block rows in the parity check matrix.

4. The method of claim 1, wherein the time is proportional to the number of I's in a parity check matrix H(t) associated with the low density parity check (LDPC) code.

5. The method of claim 1, wherein the decoding time independent of the size of an associated square sub-block matrix.

6. The method of claim 1, wherein the same decoder is used for decoding multi-rate codes.

7. The method of claim 1, wherein a pipelined architecture is used for bit and check update units.

8. The method of claim 1, wherein M comprises a predetermined size of a square sub-block.

9. A low density parity check (LDPC) decoder having a predetermined decoder structure for decoding a low density parity check (LDPC) code suitable for decoding multi-rated LDPC codes, the decoder comprising:
a memory for the decoding with the memory size proportional to the number of circularly shifted-identity matrices I (t); and
a number M for both row update unit numbers and column-update unit numbers;
whereby an improved architecture in a logic and the memory is provided such that an improved throughput, power consumption, and memory area is achieved.

10. The decoder of claim 9, wherein the decoder structure is independent of the number of 1's in each row (check-node degree) or the number of 1's in each column (bi-node degree).

11. The decoder of claim 9, wherein the decoder structure is independent of the number of block columns or block rows in the parity check matrix.

12. The decoder of claim 9, wherein the time is proportional to the number of I's in a parity check matrix H(t) associated with the low density parity check (LDPC) code.

13. The decoder of claim 9, wherein the decoding time independent of the size of an associated square sub-block matrix.

14. The decoder of claim 9, wherein the same decoder is used for decoding multi-rate codes.

15. The decoder of claim 9, wherein a pipelined architecture is used for bit and check update units.

16. The decoder of claim 9, wherein M comprises a predetermined size of a square sub-block.
